(19) United States
(12) Patent Application Publication
(10) Pub. No.: US 2004/0002430 A1
(43) Pub. Date: Jan. 1, 2004

(54) Using a time critical wafer cleaning solution by combining a chelating agent with an oxidizer at point-of-use

(75) Inventor: Steven Verhaverbeke, San Francisco, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 10/188,174

(22) Filed: Jul. 1, 2002

(51) Int. Cl. B08B 3/02; C11D 1/00

(52) U.S. Cl. 510/175; 134/36; 134/33; 134/3; 134/153; 134/902; 134/100.1

(57) ABSTRACT

A wafer cleaning solution that includes a solution of NH4OH, a carboxylic acid based chelating agent, H2O, and an oxidizer.

### FIELD OF THE INVENTION

The present invention pertains in general to wafer processing and in particular to a single wafer cleaning process and apparatus.

### BACKGROUND OF THE INVENTION

One of the most important tasks in semiconductor industry is the cleaning and preparation of the silicon surface for further processing. The main goal is to remove the contaminants from the wafer surface and to control chemically grown oxide on the wafer surface. Modern integrated electronics would not be possible without the development of technologies for cleaning and contamination control, and further reduction of the contamination level of the silicon wafer is mandatory for the further reduction of the IC element dimensions. Wafer cleaning is the most frequently repeated operation in IC manufacturing and is one of the most important segments in the semiconductor-equipment business, and it looks as if it will remain that way for some time. Each time device-feature sizes shrink or new tools and materials enter the fabrication process, the task of cleaning gets more complicated.

Today, at 0.18-micron design rules, 80 out of ˜400 total steps will be cleaning. While the number of cleans increases, the requirement levels are also increasing for impurity concentrations, particle size and quantity, water and chemical usage and the amount of surface roughness for critical gate cleans. Not only is wafer cleaning needed now before each new process sequence, but additional steps are often required to clean up the fabrication process tools after a production run.

Traditionally, cleaning has been concentrated in the front end of the line (FEOL) where active devices are exposed and more detailed cleans required. A primary challenge in FEOL cleans is the continuous reduction in the defect levels. As a rule, a “killer defect” is less than half the size of the device line width. For example, at 0.25 μm geometries, cleans must remove particles smaller than 0.12 μm and at 0.18 μm, 0.09 μm particles.

Most cleaning methods can be loosely divided into two big groups: wet and dry methods. Liquid chemical cleaning processes are generally referred to as wet cleaning. They rely on combination of solvents, acids and water to spray, scrub, etch and dissolve contaminants from wafer surface. Dry cleaning processes use gas phase chemistry, and rely on chemical reactions required for wafer cleaning, as well as other techniques such as laser, aerosols and ozonated chemistries. Generally, dry cleaning technologies use less chemicals and are less hazardous for the environment but usually do not perform as well as wet methods, especially for particle removal.

For wet chemical cleaning methods, the RCA clean, developed in 1965, still forms the basis for most front-end wet cleans. A typical RCA-type cleaning sequence starts with the use of an H2SO4/H2O2 solution followed by a dip in diluted HF. A Standard Clean first operation (SC11) can use an alkaline solution of NH4OH/H2O2/H2O to remove SiO2 particles and metallic oxide (Al2O3, TiO2) particles. However, such mixtures are not optimized for metallic contamination. It is known that metallic contamination, such as Fe, Ni, Al and Zn, when present in the bath, even if only in trace amounts, will deposit on silicon wafers during cleaning.

For this reason, in a typical cleaning process, a second cleaning step such as a Standard Clean second operation (SC2) can be used. SC2 can use an acidic solution of HCl/H2O2/H2O to remove metals. SC2 can use an oxidizer such as hydrogen peroxide to convert any elemental metals to an ionic form and the SC2 solution can be maintained as acidic, such as with hydrochloric acid, to keep the metal ions from forming compounds and precipitating out. As ions, the metals can be removed from the wafer in a later rinsing operation.

Chelating agents are complexing agents used to prevent metal deposition and to combine with metal ions for metal removal in a liquid solution. Chelating agents can be added to the SC1 cleaning solution to potentially create a “single chemistry” cleaning solution since a final SC2 cleaning step to remove metal contamination may be omitted. Even if SC2 is used, a reduction of the total amount of cleaning solutions used and/or a reduction in the total cleaning time per wafer may be accomplished with chelating agents.

Suitable chelating agents can include chemistry types that are carboxylic acid, phosphoric acid, sulfuric acid, and alcohol based. The desired action of a chelating agent is to bind with metal atoms. However, many of the more effective chelating agents, such as, for example, the carboxylic acids, and namely ethylenediaminetetraacetic acid (EDTA), N,N′-bis (2-hydroxyphenyl) ethylenediaminodiacetic acid (HPED), and ethylenediaminediorthohydroxyphenylacetic acid (EDDHA) that can perform well as complexing agents are not stable in an oxidizing environment such as, for example, the RCA SC1 chemistry.

Despite increasingly stringent process demands and orders of magnitude improvements in analytical techniques, the cleanliness of chemicals such as with the use of ultra pure water, the basic cleaning recipes have remained unchanged since the first introduction of this cleaning technology. Since environmental concerns and cost-effectiveness were not a major issue 30 years ago, the RCA cleaning procedure is far from optimal in these respects.

Megasonic agitation is the most widely used approach to adding energy (at about 800 kHz or greater) to the wet cleaning process. The physics behind how the use of megasonics improves particle removal from a wafer, however, is not well understood. A combination of, an induced flow in the cleaning solution on the wafer (called acoustic streaming), cavitation effects, the level of dissolved gases in the cleaning solution, and oscillatory effects, are all thought to contribute to this improved efficiency when megasonics is added to wet-chemistry cleaning.

### SUMMARY OF THE INVENTION

In the present invention, a method and apparatus for enhancing thie cleaning operation on a wafer in a single wafer cleaning chamber is disclosed. It is one aspect of the present invention to mix a cleaning solution having an optimized formulation but where such mixture can have a short useful life. In one embodiment, the mixture can present a strong oxidizing environment, such as, for example, the Standard Clean 1 (SC1) solution with a chelating agent that is a carboxylic acid base. Once placed in the oxidizing environment, the carboxylic acid based chelating agent will begin to degrade. In the present invention, the chelating agent can be mixed with the oxidizer at the location (point) where the cleaning solution will be applied (used) onto the wafer, i.e. point-of-use. With mixing occurring at point-of-use, the cleaning solution can be quickly applied onto the wafer before the useful life has expired. The point-of-use mixing can occur physically close to the application of the cleaning solution onto the wafer, where the mixed chemicals, applied to the wafer soon after mixing, can then be discarded after a single use. It is a further aspect of the present invention that the mixing at point-of-use can occur in a mixing and delivery system that uses a constant volume apparatus for providing a measured mixing of cleaning solution chemicals.

### BRIEF DESCRIPTION OF THE DRAWINGS

The present invention is illustrated by way of example and not limitation in the figures of the accompanying drawings, in which like references indicate similar elements and in which:

FIG. 1 is a graph showing curves of active chelating agent over time after mixing under different conditions.

FIG. 2 is an illustration of one embodiment of a single wafer cleaning chamber.

FIG. 3 is an illustration of one embodiment of a constant volume mixing system.

FIG. 4 is flow diagram of one embodiment of a method for point-of-use mixing of chelating agents with an oxidizer.

### DETAILED DESCRIPTION

For purposes of discussing the invention, it is to be understood that various terms are used by those knowledgeable in the art to describe apparatus, techniques, and approaches. In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in gross form rather than in detail in order to avoid obscuring the present invention. These embodiments are described in sufficient detail to enable those skilled in the art to practice the invention, and it is to be understood that other embodiments may be utilized and that logical, mechanical, chemical, and other changes may be made without departing from the scope of the present invention.

In the present invention, a method and apparatus for enhancing the cleaning operation on wafers placed in a wafer cleaning apparatus is disclosed. The method and apparatus are specifically useful for single wafer cleaning, but the method and apparatus disclosed may also be used in applications where more than one wafer is cleaned at a time. In one aspect of the present invention, a single cleaning solution is used having an oxidizing environment and includes a carboxylic acid based chelating agent and where the solution is mixed at point-of-use to quickly apply the cleaning solution. This aspect of the present invention can use a particular cleaning solution chemistry under conditions that are optimal for cleaning but where the mixture can have a short useful life, in particular through degradation of the chelating agent by the oxidizer.

The point-of-use mixing means that the mixing can occur physically near the single wafer cleaning chamber such that the mixed chemicals can be applied to the wafer soon after mixing and the mixed chemicals can then be discarded after a single use. Point-of-use means that the point of mixing of the wafer cleaning solution is done physically close enough to the wafer cleaning chamber such that by the time the wafer cleaning solution is applied into the wafer, enough chelating agent remains active to accomplish removal of the metals within such processing parameters as, for example, cycle times, temperatures, concentrations of metals, etc. It is a further aspect of the present invention that the mixing at point-of-use can occur in a mixing and delivery system that uses a constant volume method of control.

The advantage of using chelating agents to remove metallic impurities is that the use of a chelating agent does not require an acidic environment and as a result, a single cleaning solution can be used which can reduce overall cleaning time. Other methods of removing metal ions, such as through the use of the SC2 solution, require an acidic environment. As a result, two cycles are used to clean a wafer with the metal ion removal step done separately from the SC1 step, since the SC1 chemistry is an alkaline oxidizing environment. Chelating agents however work well in alkaline environments, allowing them to be added to the SC1 solution. By combining the metal ion removal with the SC1 cleaning step, and mixing the chelating agent with the oxidizer at the point-of-use, the SC2 step can be eliminated and the overall cleaning time for a wafer can be reduced.

In an alternate embodiment, the cleaning solution contains a surface active agent (surfactant). A surfactant can prevent reattachment or re-deposition of particles on the wafer after they have been dislodged from the wafer in a cleaning cycle and as a result, the use of the surfactant can reduce wafer cleaning times. Surfactants can be non-ionic, anionic, or a mixture of non-ionic and anionic chemistry. Non-ionic means that the polar end of the surfactant has an electrostatic rather than an ionic charge and anionic means that the polar end of the surfactant has a negative ionic charge.

In one alternate embodiment, the surfactant can be a mixture of non-ionic and anionic surfactants, such as, for example, the nonionic surfactant can be polyoxyethylene butylphenyl ether and the anionic surfactant can be polyoxyethylene alkylphenyl sulfate. In the alternate embodiment, there can be approximately 30 ppm of nonionic surfactant and approximately 30 ppm of anionic surfactant in the final cleaning solution as applied onto the wafer.

In one embodiment of a cleaning solution, an SC1 type wafer cleaning solution can consist of a mixture of ammonium hydroxide (NH4OH), hydrogen peroxide (H2O2), water (H2O), a carboxylic acid based chelating agent, and a surfactant to be applied onto a wafer during the wafer cleaning process. However, other oxidizers can be used such as O3. The water can dissociate the carboxylic acid based chelating agent, ammonium hydroxide, the hydrogen peroxide and possibly the surfactant into their respective ions. In one embodiment, as applied to the wafer, the ammonium hydroxide, hydrogen peroxide, and water can be present in concentrations defined by volumetric ratios of between 5/1/1 to 1000/1/1, respectively. The ammonium hydroxide/hydrogen peroxide ratio can also be varied between 0.05/1 and 5/1 and the ammonium hydroxide in this cleaning solution can be a solution of 28-29% by weight of NH3 to water. The hydrogen peroxide in this cleaning solution can be 31-32% by weight of H2O2 to water.

The purpose of the ammonium hydroxide and the hydrogen peroxide in the cleaning solution can be to remove particles and residual organic contaminates from a wafer that is a monocrystalline silicon substrate on at least the front end of wafer processing. The purpose of the cleaning solution can also be to oxidize the surface of the wafer to passivate the surface. In one embodiment, the alkaline cleaning solution can have a pH level of between 9 and 12, and more specifically between 10 and 11, as a result of the presence of the ammonium hydroxide and the hydrogen peroxide. The combined volume of NH4OH+chelating agent, H2O2, surfactant, and water used to clean a single wafer can be approximately 1 liter. The total use of DI water used in a cleaning cycle to rinse a single wafer can be approximately 5 liters.

Chelating agents can be used to remove such metallic ions from the wafer as, copper, iron, nickel, aluminum, calcium, magnesium, and zinc, however, other metallic ions may also be present. Chelating agents are also known as complexing or sequestering agents where these agents can have negatively charged ions called ligands that can bind with free metal ions to form a combined complex that will remain soluble.

In one embodiment, the cleaning chemistry can include a NH4OH/carboxylic acid based chelating agent pre-mix that can be approximately 3000 ppm chelating agent in a solution of 28% NH4OH with water. Where upon final mixing of the cleaning solution, further ultra pure water, such as deionized (DI) water, along with H2O2, can be added to complete the formulation. Alternatively, all of the water needed can be pre-mixed with the H2O2 such that only the mixing of the H2O2/DI H2O with the NH4OH/chelating agent solution may be required to create the cleaning solution formula.

The best performing chelating agents for removing metals from contaminated wafers can be of the carboxylic acids types such as, for example, EDDHA (ethylenediaminediorthohydroxyphenylacetic acid), EDTA, (ethylenediaminetetraacetic acid), or HPED, (N,N′-bis (2-hydroxyphenyl) ethylenediaminodiacetic acid). These chelating agents are particularly effective because they have an equilibrium constant (k) greater than 10¹⁵, and preferably greater than 10²⁰ for trivalent aluminum (Al³⁺). Such a high k can mean that the chelating agent will effectively remove the metals from the wafer.

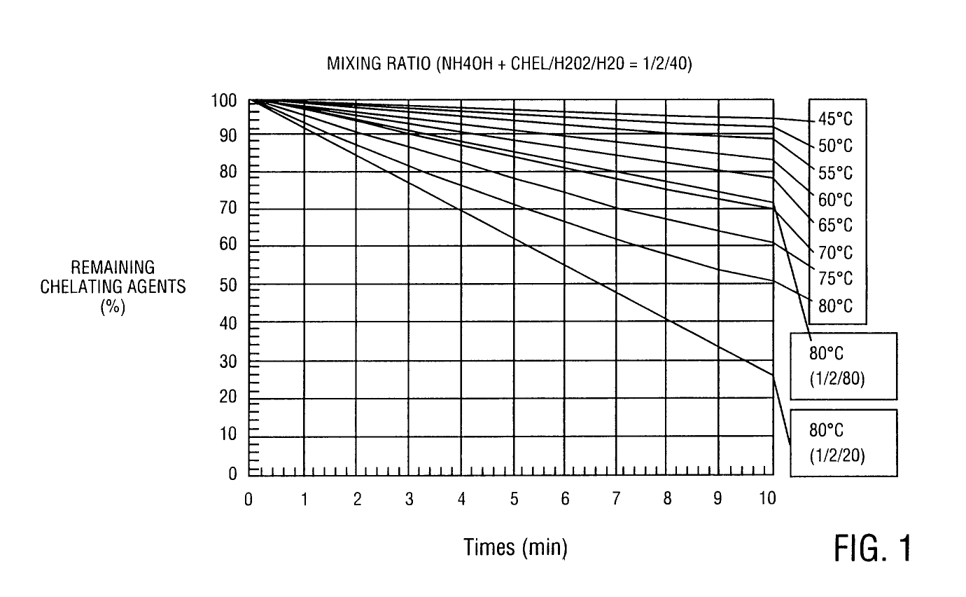

FIG. 1 is a graph of curves for solutions containing a carboxylic acid based chelating agent degrading in an oxidizing environment over time. The curves illustrate the percentage of chelating agent remaining active (i.e. able to bind with metals) over time for various concentrations and temperatures. The chelating agent used to generate the curves is EDDHA and the NH4OH+chelating agent mixture used in the mixing ratios is 3000 parts per million (ppm) chelating agent in a 28% solution of HN4OH (i.e. 28% NH3 in water by wt.). Upon entering an oxidizing environment, here generated by H2O2, the carboxylic acid based chelating agent can begin to degrade. The rate of degradation can depend on various factors, such as, for example, the specific chelating agent, the temperature of the mixture, and the type and concentration of oxidizer.

As a result of curves generated, such as, for example, those shown in FIG. 1, the amount of active chelating agent remaining after any period of time can be calculated. Based on such curves, a design for point-of-use can be accomplished where the distance between the mixing of the cleaning solution and the wafer cleaning chamber can be determined based on the amount of time available between mixing and application onto a wafer. Optimizing wafer cleaning cycle times can limit the amount of time allowed for the cleaning solution to act on the wafer surface. Based on that amount of time and the amount of metal ions to be removed, concentrations of oxidizer and active chelating agent in the mixture, as well as the distance between the mixing and the wafer cleaning chamber (i.e. that define point-of-use for a given application), can be determined.

In one embodiment, when cleaning a single wafer with a SC1 solution, a concentration of EDDHA that is approximately in the range of 20-40 ppm active chelating agent when applied to a wafer for up to 60 seconds can remove most of the metal ions. The temperature of the cleaning solution when applied onto the wafer can effect chelating agent degradation by changing the complexing constant k for the chelating agent, the therefore the amount of metal complexed by the chelating agent is effected.

In one embodiment, the cleaning solution can be at a temperature of approximately 70° C. and where point-of-use requires that mixing be accomplished close enough such that the mixture can be applied to the wafer within 2 minutes of when the EDDHA chelating agent has been placed in the oxidizing environment. In addition, the mixture can be used, i.e. remain on the wafer for metal removal, for a time period in the range of approximately 15-60 seconds. As shown in FIG. 1, a mixture of 1/2/40 (NH4OH+chelating agent/H2O2/H2O), that is applied at approximately 70° C., will have 90% or greater of the EDDHA chelating agent still active 3 minutes after mixing. The result can be that at least 20-40 ppm active chelating agent will exist throughout use of the cleaning solution.

Single wafer cleaning has intrinsic advantages over conventional batch type of cleaning. It can be used in applications with critical timing constraints between process steps and pre- or post cleaning. In addition, single wafer cleaning can allow for better access to the wafer allowing for more optimized cleaning methods. Single wafer cleaning can also enable the integration of the cleaning step inside cluster tools leading to increased performance and reduced cycle time. Finally, single wafer cleaning can use considerably less chemicals in the cleaning process resulting in an improvement in the environment through reduced volume of chemicals placed into a water treatment/re-cycle system.

A single wafer cleaning chamber can be used to clean wafers before and after a variety of wafer processes, such as, for example, deposition of a metallized film, photoresist patterning, or Rapid Thermal Processes (RTP) where RTP can be used for such processes as wafer annealing, doping, and oxide growth. The wafer cleaning process can include a hydrofluoric acid (HF) etch on the wafer to remove oxides. As a result of these processes, there are usually metal ions in the rinse water that can remain on the wafer. It is important to remove those metal ions.

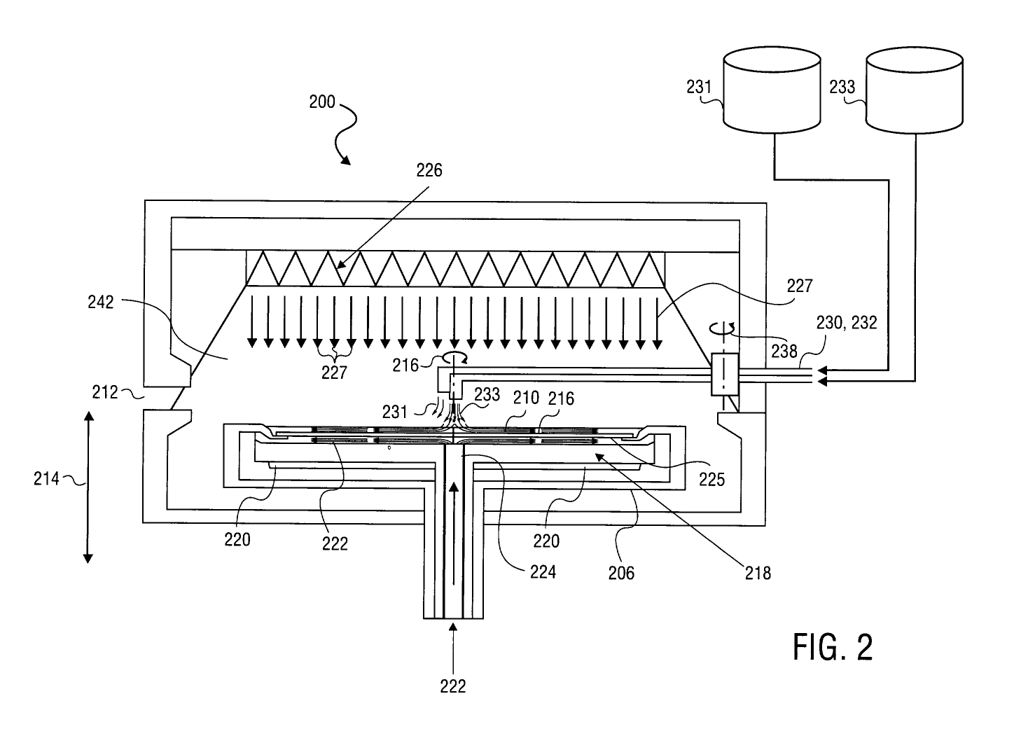

FIG. 2 is an illustration of one embodiment of a single wafer cleaning chamber in a position for wafer processing. As shown in FIG. 2, a single wafer cleaning chamber 200 can contain a translatable 214 and rotatable 216 wafer holding bracket 206. A robot arm (not shown) holding a wafer 210 can enter the chamber 200 through a wafer transfer slit 212. The arm can place the wafer 210 onto the bracket 206 where the bracket 206 is elevated to receive the wafer 210. Raising the bracket 206 can keep the robot arm and wafer 210 clear of other components in the chamber 200 during the transfer. In one embodiment, the wafer 210 can initially be maintained in position on the bracket 206 by gravity alone.

Once the wafer 210 is placed onto the bracket 206, the bracket 306 can be lowered to a process position as shown. This process position can place the wafer 310 a short distance above a circular plate 218. The circular plate 218 can be made of a sapphire ceramic, or from metals such as, for example, stainless steel or aluminum. Transducers 220 capable of emitting sound in the megasonic frequency range can be bonded to the bottom side of the circular plate 218 and where the remaining exposed surfaces of the circular plate 218 can be covered with a protective coating such as a fluoropolymer. A fluid feed port 224 can be added to the transducer plate 218 to fill an approximate 3 millimeter (mm) gap 326 between the transducer plate 218 and the wafer 210 with a liquid 222 at various times during wafer processing. The liquid 222 can act as a carrier for transferring megasonic energy onto the wafer bottom surface 225. The top of the single wafer cleaning chamber 200 can contain a filter 226 to clean air flowing 227 into the process chamber 200 and onto a top surface 216 of the wafer 210.

During the wafer cleaning operation, processing fluids such as liquids 231 and/or gasses 233 can flow onto the wafer top surface 216 through one or more nozzles 230 and 232 that can be positioned above the wafer 210 such as, for example, near or at the center of wafer rotation 216. Such nozzles 230 and 232 can be translatable such as by pivot 238 to provide clearance for bracket 206 up and down translation 214 during a wafer 210 transfer as well as to translate the flow of fluids 231 and 233 across the top surface 216 of the wafer 210 during a cleaning operation.

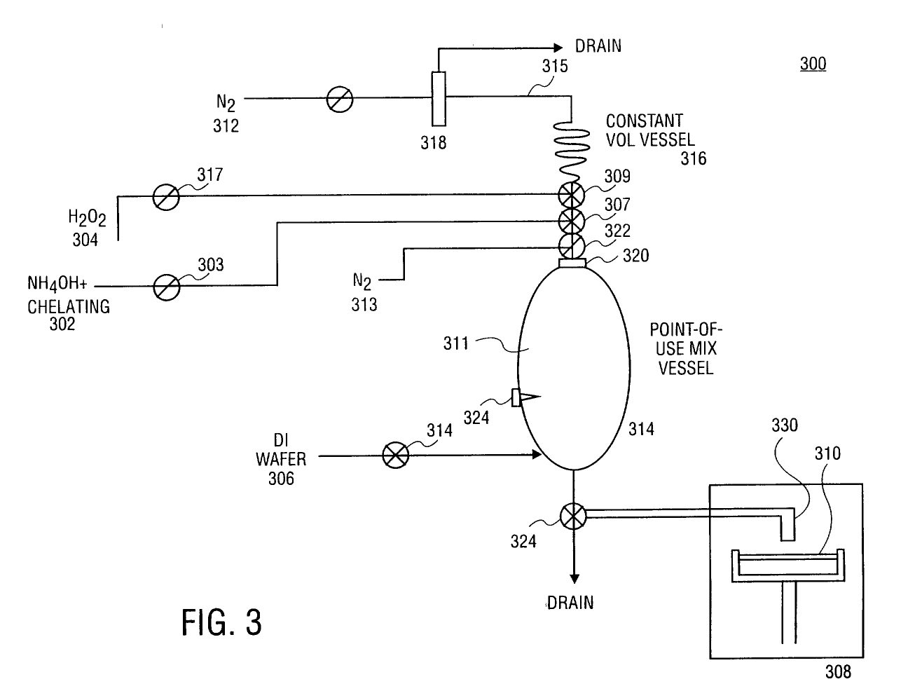

FIG. 3 is an illustration of one embodiment of a constant volume mixing system. In the constant volume mixing system 300, volumes of liquids can be accurately measured and mixed into a final solution of known concentrations of chemistry. In one embodiment, a measured volume of NH4OH that has been premixed with a chelating agent 302, can be mixed with H2O2 (304) and water (H2O) 306 and then transferred to the single wafer cleaning chamber 308 to be dispensed onto a wafer 310. The N4OH/chelating agent mixture 302 can be premixed for up to approximately six months in advance of use if stored in a stable environment such as at ambient temperature and without light. The constant volume mixing system 300 can include a source of NH4OH/chelating agent 302, a source of H2O2 (304), a source of inert gas 312 such as nitrogen (N2), and a source of pure water such as deionized (DI) water 306.

A point-of-use mixing vessel 314 can receive chemicals that, once mixed, can be transferred into the single wafer cleaning chamber 308 for application onto a wafer 310 within a required period of time. In one embodiment, the point-of-use mixing vessel 314 can have a volume of approximately 1 liter that when filled with a cleaning solution 311, the cleaning solution 311 will be completely or almost completely dispensed onto the single wafer 310 during the cleaning of the wafer 310. A constant volume vessel 316 can exist to measure an accurate volume of the pre-mixture of NH4OH and chelating agent 302. Valves 303 and 305 and a multi-direction valve 307 can open to flow the pre-mixed NH4OH/chelating agent 302 into the constant volume vessel 316 with access to the point-of-use mixing vessel 314 closed by the multi-direction valve 377.

The NH4OH/chelating agent mixture 302 can flow through the constant volume vessel 316 until reaching a separator 318. The separator 318 can allow gasses to pass but can block liquids such as the pre-mixed NH4OH/chelating agent solution 302. When the flow of NH4OH/chelating agent solution 302 reaches the separator 318, the multi-direction valve 317 can close off the source of NH4OH/chelating agent solution 302 and open access to the point-of-use mixing vessel 314. The volume between the separator and the multi-direction valve 307 can include the tubing 315 and the constant volume vessel 316 and is set by design.

Next, the multi-direction valve 307 and source valve 303 can close off access to the source of NH4OH/chelating agent solution 302. A second multi-direction valve 309 and a second source valve 317 can open to flow from a source of H2O2 that is diluted in water (304). The multi-direction valve 309 can allow flow of H2O2 (304) into the point-of-use mixing vessel 314 and at the same time block flow of H2O2 (304) toward the constant volume vessel 316. The flow of H2O2 (304) can continue until the amount of oxidizer required has been delivered where a sensor 324 can determine when enough oxidizer 304 has been delivered to the point-of-use mixing vessel 314.

Alternatively, a known volume of H2O2 can be delivered with a constant volume vessel system similar to the one used to deliver NH4OH and chelating agent. Next, a source of DI water 306 can be open to fill the point-of-use mixing vessel 314 such that when the fluid level within the point-of-use mixing vessel 314 rises to level a fluid level sensor can close the valves 317 and 309 to stop the flow of H2O2 (304). The DI water 306 can be heated to a temperature calculated to provide a pre-determined overall mixed cleaning solution temperature. A source valve 314 for the DI water can be open to fill the point-of-use mixing vessel 314. A fluid sensor 320 can sense the level of liquid within the point-of-use mixing vessel 314 and turn off the DI water source valve 314.

In this embodiment, a known (measured) volume of chemicals 311 is now positioned within the point-of-use mixing vessel 314 at a temperature. The known volume of chemicals 311 contains an accurately measured amount of NH4OH/chelating agent, H2O2, and H2O. The volume of mixed chemicals 311 is sufficient to process a single wafer 310 in the single wafer cleaning chamber 308. A valve 322 can open allowing a gas 313, such as, for example N2 to apply pressure to the top of the chemicals 311 in the point-of-use mixing vessel 314. Upon opening a valve 324 downstream of the point-of-use mixing vessel 314, the gas 313 can cause the chemicals 311 to transfer into the single wafer cleaning chamber 308 to flow through a nozzle 330 and onto the wafer 310 during the wafer cleaning process.

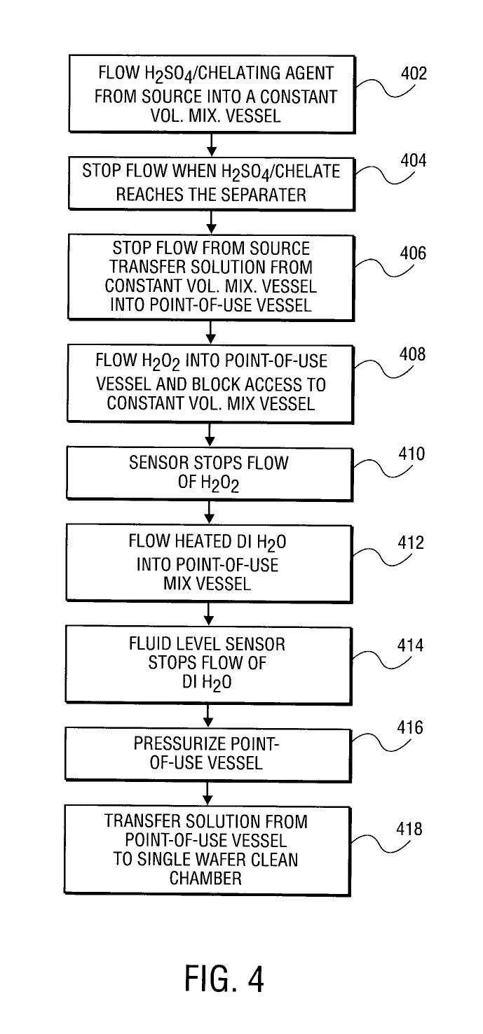

FIG. 4 is a flow diagram of one embodiment of a method of use of the constant volume mixing system. In the one embodiment of the method of use, a source valve and a multi-direction valve can open to flow NH4OH/chelating agent, through the constant volume vessel and up to a separator (operation 402). Upon reaching the separator, the NH4OH/chelating agent source and the multi-direction valve close off the NH4OH/chelating agent solution source. A known volume of NH4OH/chelting agent is now maintained in the constant volume vessel (operation 404). The multi-direction valve is re-positioned to allow the known volume of NH4OH/chelating agent to flow into the point-of-use vessel (operation 406). A second source valve and a second multi-direction valve now open to allow a flow of H2O2 into the point-of-use mixing vessel while blocking flow of H2O2 into the constant volume vessel (operation 408). Flow of H2O2 continues until an oxidizer sensor triggers the flow to stop (operation 410). Next, a flow of heated DI water can flow into the point-of-use mixing vessel (operation 412). A fluid level sensor trips closure of the DI water source valve (operation 414). A gas valve can open to apply gas pressure onto the top fluid surface of the cleaning solution within the point-of-use mixing vessel (operation 416). A valve can now open at the bottom of the point-of-use mixing vessel to allow the gas pressure, acting on the cleaning solution within the point-of-use mixing vessel, to transfer the cleaning solution into the single wafer cleaning chamber (operation 418).

In one embodiment, the H2O2 and NH4OH/chelating agent chemistry can be dispensed into the constant volume mixing system at a temperature. The DI water can be dispensed into the constant volume mixing system at temperatures high enough to elevate the overall cleaning solution to a temperature. After mixing the cleaning solution in the constant volume mixing system, the mixture can be applied to the wafer quickly, where, in one embodiment, the mixture is applied within 2 minutes and is maintained on the wafer for up to 45 seconds.

Thus a method and apparatus for removing metals from a wafer is described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A wafer cleaning solution, comprising:
a solution of NH4OH;
a carboxylic acid based chelating agent;
H2O; and
an oxidizer.

2. The wafer cleaning solution of claim 1, wherein the carboxylic acid based chelating agent is chosen from the group consisting of EDDHA, EDTA, and HPED.

3. The wafer cleaning solution of claim 1, wherein the carboxylic acid concentration in the cleaning solution is approximately in the range of 10-500 ppm.

4. The wafer cleaning solution of claim 1, wherein the carboxylic acid concentration in the cleaning solution is approximately in the range of 20-40 ppm.

5. The wafer cleaning solution of claim 1, wherein more than one type of chelating agent is used.

6. The wafer cleaning solution of claim 1, wherein the oxidizer is O2.

7. The wafer cleaning solution of claim 1, wherein the oxidizer is H2O2.

8. The wafer cleaning solution of claim 7, wherein the mixing ratio for NH4OH/H2O2/H2O is approximately in the range 1/2/20-1/2/200 by volume respectively.

9. The wafer cleaning solution of claim 7, wherein the H2O2 is a solution of approximately between 25-32% H2O2 by weight in water.

10. The wafer cleaning solution of claim 1, wherein the NH4OH solution is of approximately between 25-35% by weight in water.

11. The wafer cleaning solution of claim 1, wherein the concentration of carboxylic acid based chelating agent is in the range of approximately 20-40 ppm.

12. The wafer cleaning solution of claim 1, wherein the pH is in the range of approximately 9-12.

13. The wafer cleaning solution of claim 1, further comprising a surfactant.

14. A method of processing a single wafer, comprising:
rotating a wafer in a wafer holding bracket;
mixing at point-of-use cleaning solution that includes a carboxylic acid based chelating agent and an oxidizer; and
using the cleaning solution to clean the wafer prior to degradation of the chelating agent by the oxidizer.

15. The method of claim 14, further including mixing NH4OH and H2O into the point-of-use cleaning solution.

16. The method of 15, wherein the H2O is pre-heated.

17. The method of claim 16, where the H2O is pre-heated to a range of approximately 45-80 degrees C.

18. The method of claim 14, further including mixing a surfactant in the point-of-use cleaning solution.

19. The method of claim 14, wherein the volume of point-of-use cleaning solution processes one wafer.

20. The method of claim 15, wherein a volume of H2O to process a single wafer is approximately 1 liter.

21. The method of claim 14, wherein the point-of-use cleaning solution is applied to the wafer within 2 minutes of mixing.

22. The method of claim 15, wherein the NH4OH is pre-mixed with the carboxylic acid based chelating agent before the point-of-use mixing.

23. A method of using a point-of-use mixing system, comprising:
pre-mixing NH4OH with a chelating agent that is a carboxylic acid;
filling a first constant volume vessel with the chelating agent and NH4OH pre-mix to a first measured volume;
transferring the measured volume from the first constant volume vessel into a point-of-use mixing vessel;
transferring an oxidizer into the point-of-use mixing vessel;
adding water to the point-of-use mixing vessel;
transferring the contents of the point-of-use mixing vessel into a wafer cleaning chamber.

24. The method of claim 23, wherein the oxidizer fills a second constant volume vessel to a second measured volume, and the second measured volume is transferred to the point-of-use mixing vessel.

25. The method of claim 23, wherein H2O is pre-mixed with the oxidizer.

26. The method of claim 23, wherein the oxidizer is transferred into the point-of-use mixing vessel until a sensor determines an oxidizing level and stops further transfer of the oxidizer.

27. The method of claim 23, wherein the oxidizer is H2O2.

28. The method of claim 23, wherein the contents of the point-of-use mixing vessel are transferred onto at least one wafer within a range of approximately 2-10 minutes after mixing.

29. A single wafer cleaning chamber, comprising:
a rotatable bracket capable of holding a wafer;
a chemical point-of-use mixing system; and
a nozzle capable of flowing the chemicals from the chemical point-of-use mixing system onto a wafer.

30. The single wafer cleaning chamber of claim 29, wherein the chemical point-of-use mixing system is capable of measuring a volumetric amount of chemicals to process a single wafer.

31. The single wafer cleaning chamber of claim 29, wherein the chemical point-of-use mixing system includes a separator.

32. The single wafer cleaning chamber of claim 29, wherein the chemical point-of-use mixing system is capable of transferring chemicals from the chemical point-of-use mixing system onto a wafer within approximately in the range of 2-10 minutes.

33. An apparatus, comprising:
a rotatable bracket capable of holding a wafer;
means for a point-of-use mixing of chemicals; and
a nozzle for flowing the mixed chemicals onto the wafer.

34. The apparatus of claim 33, further comprising:
means for applying the mixed chemicals to the wafer within a period of time.
